(19) United States
(12) Patent Application Publication
(10) Pub. No.: US 2011/0276672 A1
(43) Pub. Date: Nov. 10, 2011

(54) METHOD AND APPARATUS FOR PERFORMING PAIRING BETWEEN COORDINATOR AND DEVICE IN NETWORK, METHOD AND APPARATUS FOR PERFORMING PAIRING BETWEEN DEVICES, NETWORK SYSTEM INCLUDING THE COORDINATOR AND THE DEVICES

(75) Inventors: Hyuk-choon KWON, Seoul (KR); Hae-young JUN, Seoul (KR); Ho-dong KIM, Seoul (KR); Soo-yeon JUNG, Seoul (KR)

(73) Assignee: SAMSUNG ELECTRONICS CO., LTD., Suwon-si (KR)

(21) Appl. No.: 13/102,693

(22) Filed: May 6, 2011

Related U.S. Application Data
(60) Provisional application No. 61/333,855, filed on May 12, 2010.
(60) Provisional application No. 61/332,271, filed on May 7, 2010.
(60) Provisional application No. 61/332,322, filed on May 7, 2010.

(30) Foreign Application Priority Data
Nov. 18, 2010 (KR) 10-2010-0115119

(51) Int. Cl. G06F 15/177

(52) U.S. Cl. 709/222

(57) ABSTRACT

Provided are methods and apparatuses for performing pairing. A method of performing pairing between a coordinator and a peer device that is one from among a plurality of devices in a network including the plurality of devices and the coordinator includes: broadcasting a beacon including first pairing information indicating that the coordinator is a device to perform pairing; receiving, from the peer device, second pairing information indicating that the peer device is a peer device to perform pairing; and broadcasting a beacon including the first pairing information and the second pairing information, or the first pairing information and the second pairing information.

### CROSS-REFERENCE TO RELATED PATENT APPLICATIONS

This application claims the benefit of U.S. Provisional Application No. 61/332,322, filed on May 7, 2010, U.S. Provisional Application No. 61/332,271, filed on May 7, 2010, and U.S. Provisional Application No. 61/333,855, filed on May 12, 2010, and claims priority from Korean Patent Application No. 10-2010-0115119, filed on Nov. 18, 2010 in the Korean Intellectual Property Office, the disclosures of which are incorporated herein in their entireties by reference.

### BACKGROUND

1. Field

Apparatuses and methods consistent with exemplary embodiments relate performing pairing between a coordinator and a device in a network, performing pairing between devices, and a network system including the coordinator and the devices.

2. Description of the Related Art

Recently, a variety of near field communication methods, such as Wi-Fi, Bluetooth, and the like, have been widely used as communication protocols between devices. In such near field communication methods, a communication protocol between devices can be more easily set by using Wi-Fi Direct, Wi-Fi Protected Setup (WPS), or the like. In this regard, setting of a communication protocol so as to perform communication between devices is referred to as pairing.

Also, a communication method using a 60 GHz frequency band so as to perform large-capacity high-speed transmission has been identified as an extended type of Wi-Fi communication method. A method of performing pairing between devices is needed in the communication method using a 60 GHz frequency band.

### SUMMARY

Exemplary embodiments provide a method and an apparatus for performing pairing between a coordinator and a device in a network, a method and an apparatus for performing pairing between devices, and a network system including the coordinator and the devices.

According to an aspect of an exemplary embodiment, there is provided a method of performing pairing between a coordinator and a peer device that is one from among a plurality of devices in a network including the plurality of devices and the coordinator, the method including: broadcasting a beacon including first pairing information indicating that the coordinator is a device to perform pairing; receiving second pairing information indicating that the peer device is a peer device to perform pairing, from the peer device; and broadcasting a beacon including the first pairing information and the second pairing information, or the first pairing information and the second pairing information.

The first pairing information may include at least one of first Push Button Configuration (PBC) information indicating that a button for instructing to perform pairing has been pushed in the coordinator, and a media access control (MAC) address of the coordinator, and the second pairing information may include at least one of second PBC information indicating that a button for instructing to perform pairing has been pushed in the peer device, and an MAC address of the peer device.

The broadcasting the first pairing information and the second pairing information may include broadcasting the first pairing information and the second pairing information in one time period from among time periods in which data transmission between the peer device and the coordinator is performed, or broadcasting the first pairing information and the second pairing information in an announcement time period for notifying information in the network.

According to an aspect of another exemplary embodiment, there is provided a method of performing pairing between a coordinator and a peer device that is one from among a plurality of devices in a network including the plurality of devices and the coordinator, the method including: broadcasting first pairing information indicating that the coordinator is a device to perform pairing; and receiving the first pairing information and second pairing information indicating that the peer device is a peer device to perform pairing, from the peer device.

The method may further include, if a button for instructing to perform pairing is pushed in the coordinator, generating time schedule information including a time period for broadcasting the first pairing information, wherein the broadcasting the first pairing information is performed based on the time schedule information.

According to an aspect of another exemplary embodiment, there is provided a method of performing pairing between a coordinator and a peer device that is one from among a plurality of devices in a network including the plurality of devices and the coordinator, the method including: receiving second pairing information indicating that the peer device is a peer device to perform pairing, from the peer device; and broadcasting a beacon including the second pairing information and first pairing information indicating that the coordinator is a device to perform pairing, or the first pairing information and the second pairing information.

The method may further include, if the second pairing information is received from the peer device, broadcasting a beacon including the second pairing information, wherein the broadcasting the beacon including the first pairing information and the second pairing information or the first pairing information and the second pairing information is performed when a button for instructing to perform pairing is pushed in the coordinator after the beacon including the second pairing information is broadcasted.

According to an aspect of another exemplary embodiment, there is provided a method of performing pairing between a coordinator and a peer device that is one from among a plurality of devices in a network including the plurality of devices and the coordinator, the method including: receiving a schedule request to allocate a time period for broadcasting second pairing information indicating that the peer device is a device to perform pairing, from the peer device; transmitting a schedule response including information about the time period for broadcasting the second pairing information to the peer device; receiving the broadcasted second pairing information from the peer device based on the schedule response; and transmitting the second pairing information and first pairing information indicating that the coordinator is a peer device to perform pairing, to the peer device.

According to an aspect of another exemplary embodiment, there is provided a method of performing pairing between a plurality of devices through a coordinator in a network including the plurality of devices and the coordinator, the method including: receiving second pairing information indicating that a first device is a device to perform pairing, from the first device, wherein the receiving the second pairing information is performed by the coordinator; broadcasting a beacon including the second pairing information or the second pairing information, wherein the broadcasting is performed by the coordinator; receiving third pairing information indicating that a second device is a peer device to perform pairing, from the second device, wherein the receiving the third pairing information is performed by the coordinator; and broadcasting a beacon including the second pairing information and the third pairing information, or the second pairing information and the third pairing information, wherein the broadcasting is performed by the coordinator.

The broadcasting the second pairing information and the third pairing information may include broadcasting the second pairing information and the third pairing information in one time period from among time periods in which data transmission between the peer device and the coordinator is performed, or broadcasting the second pairing information and the third pairing information in an announcement time period for notifying information in the network.

The method may further include: receiving first peer confirmation information indicating that the second device becomes aware that the first device is a peer device to be paired with the second device, from the second device; and receiving second peer confirmation information indicating that the first device becomes aware that the second device is a peer device to be paired with the first device, from the first device.

The second pairing information may include at least one of second Push Button Configuration (PBC) information indicating that a button for instructing to perform pairing has been pushed in the first device, and an MAC address of the first device, and the third pairing information may include at least one of third PBC information indicating that a button for instructing to perform pairing has been pushed in the second device, and an MAC address of the second device.

The method may further include, if the beacon including the second pairing information or the second pairing information is received by the second device, buffering the received second pairing information by the second device; and if a button for instructing to perform pairing is pushed in the second device, becoming aware that the first device is a peer device of the second device based on the buffered second pairing information, wherein the third pairing information is transmitted from the second device to the coordinator when the second device becomes aware that the first device is a peer device of the second device.

If the second pairing information is received by the second device before the button for instructing to perform pairing is pushed in the second device, the second device may ignore the received second pairing information, and if the second pairing information is received by the second device after the button for instructing to perform pairing is pushed in the second device, the second device may become aware that the first device is a peer device of the second device, and the third pairing information is transmitted from the second device to the coordinator when the second device becomes aware that the first device is a peer device of the second device.

According to an aspect of another exemplary embodiment, there is provided a method of performing pairing between a plurality of devices through a coordinator in a network including the plurality of devices and the coordinator, the method including: transmitting second pairing information indicating that the first device is a device to perform pairing, to the coordinator, wherein the transmitting the second pairing information is performed by the first device; broadcasting a beacon including the second pairing information or the second pairing information, wherein the broadcasting is performed by the coordinator; and transmitting the second pairing information and third pairing information indicating that the second device is a peer device to perform pairing, to the first device, wherein the transmitting of the second pairing information and the third pairing information is performed by the second device.

The method may further include: transmitting a time allocation request to allocate a time period for transmitting data, to the coordinator, wherein the transmitting of the time allocation request is performed by the second device; and transmitting a time allocation response including information about the time period allocated to the second device for transmission of the data, wherein the transmitting the time allocation response is performed by the coordinator, wherein the first device and the second device mutually transmit data based on the time allocation response.

According to an aspect of another exemplary embodiment, there is provided a method of performing pairing between a plurality of devices through a coordinator in a network including the plurality of devices and the coordinator, the method including: transmitting second pairing information indicating that the first device is a device to perform pairing, to the coordinator, wherein the transmitting the second pairing information is performed by the first device; broadcasting a beacon including the second pairing information or the second pairing information, wherein the broadcasting is performed by the coordinator; transmitting third pairing information indicating that the second device is a peer device to perform pairing, to the coordinator, wherein the transmitting the third pairing information is performed by the second device; and transmitting the third pairing information to the first device, wherein the transmitting is performed by the coordinator.

The method may further include, when the transmitting of the third pairing information to the coordinator is performed by transmitting a time allocation request that includes the third pairing information to allocate a time period for transmitting data to the coordinator by the second device, transmitting a time allocation response including information about the time period allocated to the second device for transmission of the data, to the second device, wherein the transmitting the time allocation response is performed by the coordinator.

According to an aspect of another exemplary embodiment, there is provided a method of performing pairing between a plurality of devices through a coordinator in a network including the plurality of devices and the coordinator, the method including: transmitting a schedule request to allocate a time period for broadcasting second pairing information indicating that a first device is a device to perform pairing, to the coordinator, wherein the transmitting the schedule request is performed by the first device; transmitting a schedule response including information about the time period allocated to the first device for broadcasting of the second pairing information, to the first device, wherein the transmitting is performed by the coordinator; broadcasting the second pairing information based on the schedule response, wherein the broadcasting the second pairing information is performed by the first device; and transmitting the second pairing information and third pairing information indicating that the second device is a peer device to perform pairing, to the first device, wherein the transmitting the second pairing information and the third pairing information is performed by the second device.

According to an aspect of another exemplary embodiment, there is provided a coordinator for performing pairing between a coordinator and a peer device that is one from among a plurality of devices in a network including the plurality of devices and the coordinator, the coordinator including: a transmitting unit broadcasting a beacon including first pairing information indicating that the coordinator is a device to perform pairing; and a receiving unit receiving second pairing information indicating that the peer device is a peer device to perform pairing, from the peer device, wherein the transmitting unit broadcasts a beacon including the first pairing information and the second pairing information, or the first pairing information and the second pairing information.

According to an aspect of another exemplary embodiment, there is provided a coordinator for performing pairing between a coordinator and a peer device that is one from among a plurality of devices in a network including the plurality of devices and the coordinator, the coordinator including: a transmitting unit broadcasting first pairing information indicating that the coordinator is a device to perform pairing; and a receiving unit receiving the first pairing information and second pairing information indicating that the peer device is a peer device to perform pairing, from the peer device.

The coordinator may further include, if a button for instructing to perform pairing is pushed in the coordinator, a schedule information generating unit generating time schedule information including a time period for broadcasting the first pairing information, wherein the transmitting unit broadcasts the first pairing information based on the time schedule information.

According to an aspect of another exemplary embodiment, there is provided a coordinator for performing pairing between a coordinator and a peer device that is one from among a plurality of devices in a network including the plurality of devices and the coordinator, the coordinator including: a receiving unit receiving second pairing information indicating that the peer device is a device to perform pairing, from the peer device; and a transmitting unit broadcasting a beacon including the second pairing information and first pairing information indicating that the coordinator is a device to perform pairing, or the first pairing information and the second pairing information.

According to an aspect of another exemplary embodiment, there is provided a coordinator for performing pairing between a coordinator and a peer device that is one from among a plurality of devices in a network including the plurality of devices and the coordinator, the coordinator including: a receiving unit receiving a schedule request to allocate a time period for broadcasting second pairing information indicating that the peer device is a device to perform pairing, from the peer device; and a transmitting unit transmitting a schedule response including information about the time period for broadcasting the second pairing information to the first device, wherein the receiving unit further receives the broadcasted second pairing information from the first device based on the schedule response, and the transmitting unit further transmits the second pairing information and first pairing information indicating that the coordinator is a peer device to perform pairing, to the peer device.

According to an aspect of another exemplary embodiment, there is provided a coordinator for performing pairing between a plurality of devices in a network including the plurality of devices and the coordinator, the coordinator including: a receiving unit receiving second pairing information indicating that a first device is a device to perform pairing, from the first device; and a transmitting unit broadcasting a beacon including the second pairing information or the second pairing information, wherein the receiving unit further receives third pairing information indicating that a second device is a peer device to perform pairing, from the second device, and the transmitting unit broadcasts a beacon including the second pairing information and the third pairing information, or the second pairing information and the third pairing information.

According to an aspect of another exemplary embodiment, there is provided a network system including a coordinator and a plurality of devices to perform pairing through the coordinator, the network system including: a first device transmitting second pairing information indicating that the first device is a device to perform pairing, to the coordinator; a coordinator broadcasting a beacon including the second pairing information or the second pairing information; and a second device transmitting the second pairing information and third pairing information indicating that the second device is a peer device to perform pairing, to the first device.

According to an aspect of another exemplary embodiment, there is provided a network system including a coordinator and a plurality of devices to perform pairing through the coordinator, the network system including: a first device transmitting second pairing information indicating that the first device is a device to perform pairing, to the coordinator; a coordinator broadcasting a beacon including the second pairing information or the second pairing information; and a second device transmitting third pairing information indicating that the second device is a peer device to perform pairing, to the coordinator, and wherein the coordinator further transmits the third pairing information to the first device.

According to an aspect of another exemplary embodiment, there is provided a network system including a coordinator and a plurality of devices to perform pairing through the coordinator, the network system including: a first device transmitting a schedule request to allocate a time period for broadcasting second pairing information indicating that a first device is a device to perform pairing, to the coordinator; a coordinator transmitting a schedule response including information about the time period allocated to the first device for broadcasting of the second pairing information, to the first device; and if the first device broadcasts the second pairing information based on the schedule response, a second device transmitting the second pairing information and third pairing information indicating that the second device is a peer device to perform pairing, to the first device.

According to an aspect of another exemplary embodiment, there is provided a computer-readable recording medium having recorded thereon a computer program for executing the method of performing pairing between a coordinator and a peer device that is one from among a plurality of devices in a network including the plurality of devices and the coordinator, the method including: broadcasting a beacon including first pairing information indicating that the coordinator is a device to perform pairing; receiving second pairing information indicating that the peer device is a peer device to perform pairing, from the peer device; and broadcasting a beacon including the first pairing information and the second pairing information, or the first pairing information and the second pairing information.

According to an aspect of another exemplary embodiment, there is provided a computer-readable recording medium having recorded thereon a computer program for executing the method of performing pairing between a coordinator and a peer device that is one from among a plurality of devices in a network including the plurality of devices and the coordinator, the method including: broadcasting first pairing information indicating that the coordinator is a device to perform pairing; and receiving the first pairing information and second pairing information indicating that the peer device is a peer device to perform pairing, from the peer device.

According to an aspect of another exemplary embodiment, there is provided a computer-readable recording medium having recorded thereon a computer program for executing the method of performing pairing between a coordinator and a peer device that is one from among a plurality of devices in a network including the plurality of devices and the coordinator, the method including: receiving second pairing information indicating that the peer device is a peer device to perform pairing, from the peer device; and broadcasting a beacon including the second pairing information and first pairing information indicating that the coordinator is a device to perform pairing, or the first pairing information and the second pairing information.

According to an aspect of another exemplary embodiment, there is provided a computer-readable recording medium having recorded thereon a computer program for executing the method of performing pairing between a coordinator and a peer device that is one from among a plurality of devices in a network including the plurality of devices and the coordinator, the method including: receiving a schedule request to allocate a time period for broadcasting second pairing information indicating that the peer device is a device to perform pairing, from the peer device; transmitting a schedule response including information about the time period for broadcasting the second pairing information to the peer device; receiving the broadcasted second pairing information from the peer device based on the schedule response; and transmitting the second pairing information and first pairing information indicating that the coordinator is a peer device to perform pairing, to the peer device.

According to an aspect of another exemplary embodiment, there is provided a computer-readable recording medium having recorded thereon a computer program for executing the method of performing pairing between a plurality of devices through a coordinator in a network including the plurality of devices and the coordinator, the method including: receiving second pairing information indicating that a first device is a device to perform pairing, from the first device, wherein the receiving of the second pairing information is performed by the coordinator; broadcasting a beacon including the second pairing information or the second pairing information, wherein the broadcasting is performed by the coordinator; receiving third pairing information indicating that a second device is a peer device to perform pairing, from the second device, wherein the receiving of the third pairing information is performed by the coordinator; and broadcasting a beacon including the second pairing information and the third pairing information, or the second pairing information and the third pairing information, wherein the broadcasting is performed by the coordinator.

According to an aspect of another exemplary embodiment, there is provided a computer-readable recording medium having recorded thereon a computer program for executing the method of performing pairing between a plurality of devices through a coordinator in a network including the plurality of devices and the coordinator, the method including: transmitting second pairing information indicating that the first device is a device to perform pairing, to the coordinator, wherein the transmitting of the second pairing information is performed by the first device; broadcasting a beacon including the second pairing information or the second pairing information, wherein the broadcasting is performed by the coordinator; and transmitting the second pairing information and third pairing information indicating that the second device is a peer device to perform pairing, to the first device, wherein the transmitting of the second pairing information and the third pairing information is performed by the second device.

According to an aspect of another exemplary embodiment, there is provided a computer-readable recording medium having recorded thereon a computer program for executing the method of performing pairing between a plurality of devices through a coordinator in a network including the plurality of devices and the coordinator, the method including: transmitting second pairing information indicating that the first device is a device to perform pairing, to the coordinator, wherein the transmitting of the second pairing information is performed by the first device; broadcasting a beacon including the second pairing information or the second pairing information, wherein the broadcasting is performed by the coordinator; transmitting third pairing information indicating that the second device is a peer device to perform pairing, to the coordinator, wherein the transmitting of the third pairing information is performed by the second device; and transmitting the third pairing information to the first device, wherein the transmitting is performed by the coordinator.

According to an aspect of another exemplary embodiment, there is provided a computer-readable recording medium having recorded thereon a computer program for executing the method of performing pairing between a plurality of devices through a coordinator in a network including the plurality of devices and the coordinator, the method including: transmitting a schedule request to allocate a time period for broadcasting second pairing information indicating that a first device is a device to perform pairing, to the coordinator, wherein the transmitting of the schedule request is performed by the first device; transmitting a schedule response including information about the time period allocated to the first device for broadcasting of the second pairing information, to the first device, wherein the transmitting is performed by the coordinator; broadcasting the second pairing information based on the schedule response, wherein the broadcasting of the second pairing information is performed by the first device; and transmitting the second pairing information and third pairing information indicating that the second device is a peer device to perform pairing, to the first device, wherein the transmitting of the second pairing information and the third pairing information is performed by the second device.

### BRIEF DESCRIPTION OF THE DRAWINGS

The above and other features and advantages will become more apparent by describing in detail exemplary embodiments with reference to the attached drawings in which:

FIG. 1 is a flowchart illustrating a method of performing pairing between a coordinator and a device in a network, according to an exemplary embodiment;

FIG. 2 is a flowchart illustrating a method of performing pairing between a coordinator and a device in a network, according to another exemplary embodiment;

FIG. 3 is a flowchart illustrating a method of processing received information before a button installed at a device is pushed, according to an exemplary embodiment;

FIG. 4 is a flowchart illustrating a method of performing pairing between a coordinator and a device in a network, according to another exemplary embodiment;

FIG. 5 is a flowchart illustrating a method of broadcasting pairing information in a predetermined time period, according to an exemplary embodiment;

FIG. 6 is a flowchart illustrating a method of performing pairing between a coordinator and a device in a network, according to another exemplary embodiment;

FIG. 7 is a flowchart illustrating a method of performing pairing between devices through a coordinator in a network, according to an exemplary embodiment;

FIG. 8 is a flowchart illustrating a method of performing pairing between devices through a coordinator in a network, according to another exemplary embodiment;

FIG. 9 is a flowchart illustrating a method of performing pairing between devices through a coordinator in a network, according to another exemplary embodiment;

FIG. 10 is a flowchart illustrating a method of performing pairing between devices through a coordinator in a network, according to another exemplary embodiment;

FIG. 11 is a flowchart illustrating a method of performing pairing between devices through a coordinator in a network, according to another exemplary embodiment;

FIG. 12 is a flowchart illustrating a method of performing pairing between devices through a coordinator in a network, according to another exemplary embodiment;

FIG. 13 is a flowchart illustrating a method of performing pairing between devices through a coordinator in a network, according to another exemplary embodiment;

FIG. 14 is a flowchart for explaining a coordinator that performs pairing between the coordinator and a device in a network, according to an exemplary embodiment; and

FIG. 15 is a flowchart for explaining a coordinator that performs pairing between devices in a network, according to an exemplary embodiment.

### DETAILED DESCRIPTION OF EXEMPLARY EMBODIMENTS

Exemplary embodiments will now be described more fully with reference to the accompanying drawings. Expressions such as “at least one of,” when preceding a list of elements, modify the entire list of elements and do not modify the individual elements of the list.

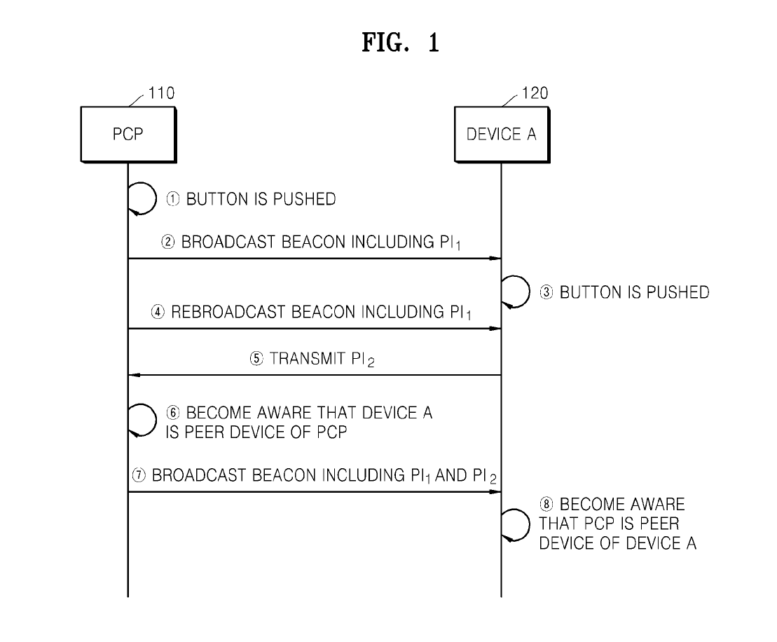

FIG. 1 is a flowchart illustrating a method of performing pairing between a coordinator and a device in a network, according to an exemplary embodiment.

Hereinafter, it is assumed that a network to which a coordinator and a plurality of devices belong is referred to as a Personal Basic Service Set (PBSS) network. The PBSS network refers to a network in which direct communication between devices is basically performed without a coordinator corresponding to an access point (AP) of a Basic Service Set (BSS) network. The coordinator may be referred to as a PBSS Control Point (PCP). In the following drawings, the coordinator is indicated by PCP.

The difference between the BSS network and the PBSS network is that, in the BSS network, an AP and devices are clearly differentiated from each other, such that a device to be used as an AP and which device to be used as a device in a network can be determined. However, in the PBSS network, devices can also operate as a PCP, such that it is relatively more difficult to differentiate a device to be used as a PCP and a device to be used as a device in a network from each other.

In addition, the PBSS network may be considered a similar network to a Wireless Personal Area Network (WPAN) system. Unlike the WPAN system that is not connected to an external network, the PBSS network may be connected to the external network. In addition, the PBSS network may support communication in a 60 GHz frequency band.

Also, FIG. 1 illustrates a PCP 110 and a device A 120. For convenience of explanation, other devices that belong to the PBSS network are omitted.

In a first operation, a button for instructing to perform pairing is pushed by a user of the PCP 110.

In a second operation, the PCP 110 broadcasts a beacon including first pairing information PI₁ indicating that the PCP 110 is a device to perform pairing.

In this case, the device A 120 receives the broadcasted beacon from the PCP 110 but ignores the received beacon because a button for instructing to perform pairing is not pushed in the device A 120. Thus, the device A 120 does not respond to the beacon received from the PCP 110.

In addition, although FIG. 1 illustrates a case where the beacon including the first pairing information PI₁ is broadcasted only to the device A 120 for convenience of explanation, it is understood that the beacon is broadcasted to all devices, including the device A 120, that belong to the PBSS network.

In addition, the first pairing information PI₁ may include first PBC information indicating that the button for instructing to perform pairing has been pushed in the PCP 110, and an MAC address of the PCP 110.

In a third operation, a button for instructing to perform pairing is pushed by a user of the device A 120.

In this way, if the button for instructing to perform pairing is pushed in the device A 120, the device A 120 can respond to the beacon received from the PCP 110. In other words, only if the beacon is received after the button for instructing to perform pairing has been pushed in the device A 120, the device A 120 accepts the received beacon as meaningful information.

A device to be paired, such as the device A 120, from among devices of the PBSS network is referred to as a peer device in the present invention.

In a fourth operation, the PCP 110 rebroadcasts the beacon including the first pairing information PI₁.

Although FIG. 1 illustrates a case where the beacon including the first pairing information PI₁ is transmitted twice in the second operation and in the fourth operation, it is understood that another exemplary embodiment is not limited thereto. For example, according to another exemplary embodiment, the beacon may be broadcasted periodically a number of times.

In a fifth operation, the device A 120 transmits to the PCP 110 second pairing information PI₂ indicating that the device A 120 is a peer device to perform pairing.

In other words, the device A 120 transmits the second pairing information PI₂ to the PCP 110 in response to the beacon including the first pairing information PI₁ received by the PCP 110.

In this regard, the second pairing information PI₂ may include second PBC information indicating that the button for instructing to perform pairing has been pushed in the device A 120, and an MAC address of the device A 120.

In a sixth operation, the device A 120 becomes aware that the PCP 110 that receives the second pairing information PI₂ from the device A 120, is a peer device of the device A 120.

In a seventh operation, the PCP 110 broadcasts a beacon including the first pairing information PI₁ and the second pairing information PI₂.

However, in another exemplary embodiment, the PCP 110 may broadcast the first pairing information PI₁ and the second pairing information PI₂, instead of the beacon including the first pairing information PI₁ and the second pairing information PI₂.

In an eighth operation, the device A 120 that receives the beacon including the first pairing information PI₁ and the second pairing information PI₂ from the PCP 110, becomes aware that the PCP 110 is a peer device of the device A 120 to perform pairing.

If the PCP 110 receives the second pairing information PI2 from the device A 120, and the device A 120 receives the first pairing information PI1 from the PCP 110 such that the PCP 110 and the device A 120 become aware that they are devices to be paired therebetween in the first through eighth operations, pairing between the PCP 110 and the device A 120 is completed. If pairing between the PCP 110 and the device A 120 is completed in this manner, data can be transmitted between the PCP 110 and the device A 120.

Although the method of performing pairing between devices by using a Push Button method according to an exemplary has been described above with reference to FIG. 1, it is understood that another exemplary embodiment is not limited thereto. For example, according to another exemplary embodiment, the user may also instruct to perform pairing to each of the PCP 110 and the device A 120 by using a remote controller.

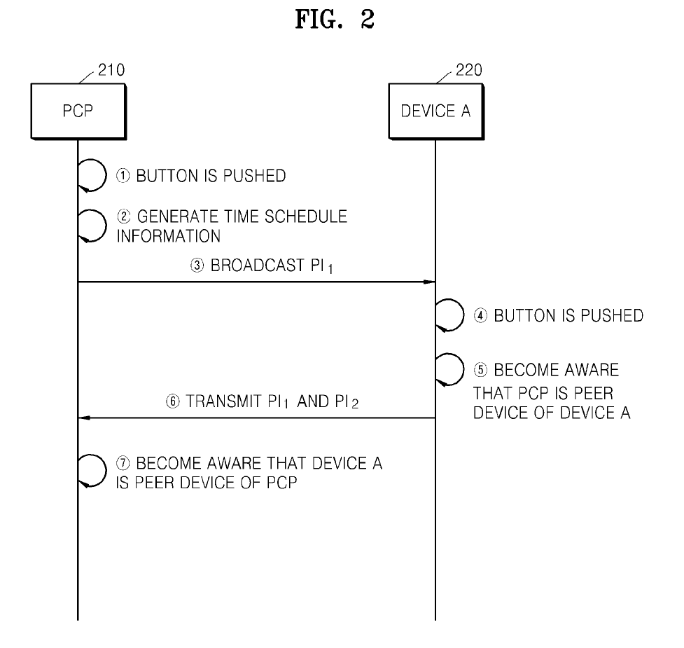

FIG. 2 is a flowchart illustrating a method of performing pairing between a coordinator and a device in a network, according to another exemplary embodiment.

In a first operation, a button for instructing to perform pairing is pushed by a user of a PCP 210.

In a second operation, the PCP 210 generates time schedule information including a time period for broadcasting first pairing information PI₁ indicating that the PCP 210 is a device to perform pairing.

In a third operation, the first pairing information PI₁ is broadcasted based on the generated time schedule information.

In a fourth operation, a button for instructing to perform pairing is pushed by a user of a device A 220.

In a fifth operation, the device A 220 becomes aware that the PCP 210 is a peer device of the device A 220 to perform pairing.

In a sixth operation, the device A 220 transmits to the PCP 210 the first pairing information PI₁ and second pairing information PI₂ indicating that the device A 220 is a peer device to perform pairing.

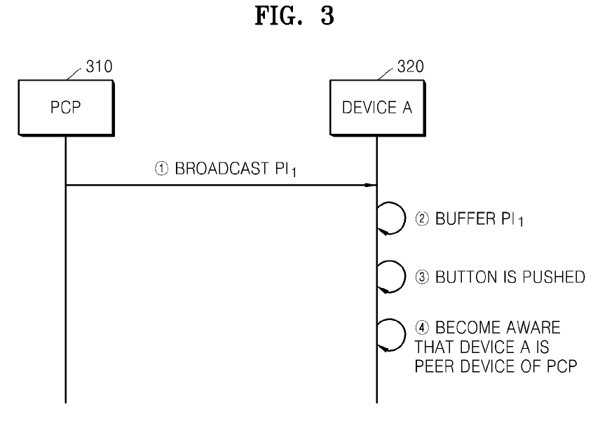

In this regard, in FIG. 2, the device A 220 does not ignore the first pairing information PI₁ received before the button for instructing to perform pairing is pushed in the device A 220, but transmits the second pairing information PI₂ in response to the received first pairing information PI₁, unlike in FIG. 1. This is because the device A 220 uses the first pairing information PI₁ received before the button for instructing to perform pairing is pushed in the device A 220 after storing the first pairing information PI₁. This will be described below with reference to FIG. 3.

In a seventh operation, the PCP 210 becomes aware that the device A 220 is a peer device of the PCP 210.

FIG. 3 is a flowchart illustrating a method of processing received information before a button installed at a device is pushed, according to an exemplary embodiment.

In a first operation, a PCP 310 broadcasts first pairing information PI₁ indicating that the PCP 310 is a device to perform pairing.

Although, in FIG. 3, the first pairing information PI₁ is broadcasted only once for convenience of explanation, it is understood that another exemplary embodiment is not limited thereto, and the first pairing information PI₁ may be periodically broadcasted to the device A 320 any number of times.

In a second operation, the device A 320 buffers the received first pairing information PI₁.

In a third operation, a button for instructing to perform pairing is pushed by a user of the device A 320.

In a fourth operation, the device A 320 becomes aware that the PCP 310 is a peer device of the device A 320 to perform pairing.

In this regard, even though the device A 320 receives the first pairing information PI₁ before the button for instructing to perform pairing is pushed in the device A 320, the device A 320 buffers the received first pairing information PI₁. Thus, even after the button is pushed in the device A 320, the device A 320 may become aware that the PCP 310 is a peer device of the device A 320 to perform pairing by using the first pairing information PI₁ buffered before the button is pushed.

Thus, the device A 320 does not need to listen to the first pairing information PI₁ rebroadcasted by the PCP 310 after the button is pushed.

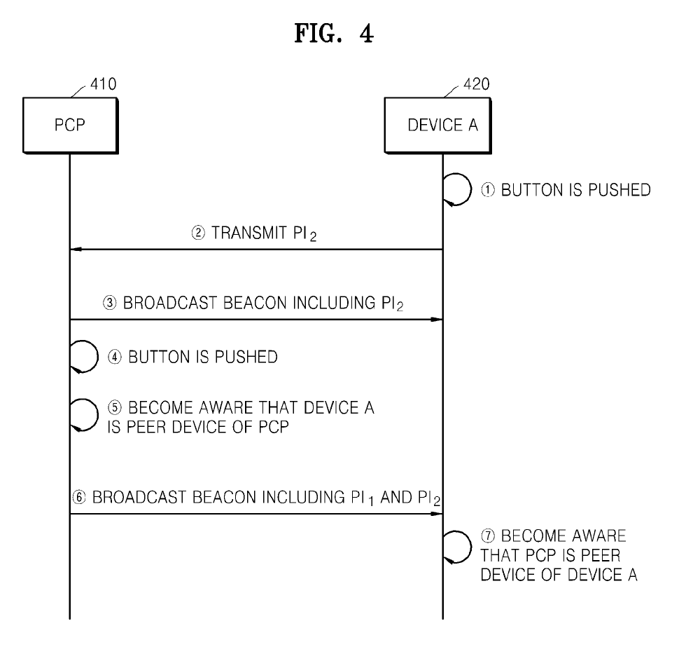

FIG. 4 is a flowchart illustrating a method of performing pairing between a coordinator and a device in a network, according to another exemplary embodiment.

In a first operation, a button for instructing to perform pairing is pushed by a user of a device A 420.

In a second operation, the device A 420 transmits to a PCP 410 second pairing information PI₂ indicating that the device A 420 is a device to perform pairing.

In a third operation, the PCP 410 broadcasts a beacon including the second pairing information PI₂.

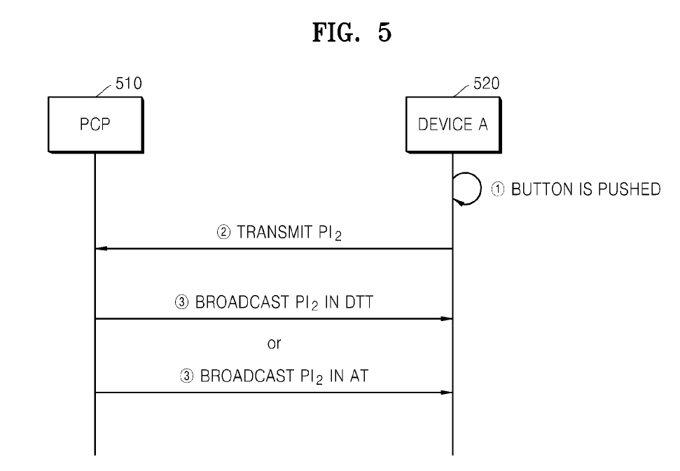

In this regard, the PCP 410 may also broadcast the beacon including the second pairing information PI₂ in a different time period, instead of broadcasting the beacon including the second pairing information PI₂ in a beacon period. This will now be described with reference to FIG. 5.

In a fourth operation, a button for instructing to perform pairing is pushed by a user of the PCP 410.

In a fifth operation, the PCP 410 becomes aware that the device A 420 is a peer device of the PCP 410.

In a sixth operation, the PCP 410 transmits to the device A 420 a beacon including the second pairing information PI₂ and first pairing information PI₁ indicating that the PCP 410 is a peer device to perform pairing.

In a seventh operation, the PCP 410 becomes aware that the device A 420 is a peer device of the PCP 410 to perform pairing.

FIG. 5 is a flowchart illustrating a method of broadcasting pairing information in a predetermined time period, according to an exemplary embodiment.

In a first operation, a button for instructing to perform pairing is pushed by a user of a device A 520.

In a second operation, the device A 520 transmits to a PCP 510 second pairing information PI₂ indicating that the device A 520 is a device to perform pairing.

In a third operation, the PCP 510 broadcasts the second pairing information PI₂ in one from among data transmission time periods or in an announcement time period for notifying information in a network.

In detail, the PCP 510 may not necessarily broadcast only a beacon including the second pairing information PI₂ in a beacon period when receiving the second pairing information PI₂, but may broadcast the second pairing information PI₂ by using the data transmission time period or the announcement time period. It is understood that the method of broadcasting the second pairing information PI₂ illustrated in FIG. 4 is applicable to any operation of broadcasting a beacon including pairing information by using a PCP according to exemplary embodiments, regardless of types of pairing information, instead of an operation of broadcasting the beacon.

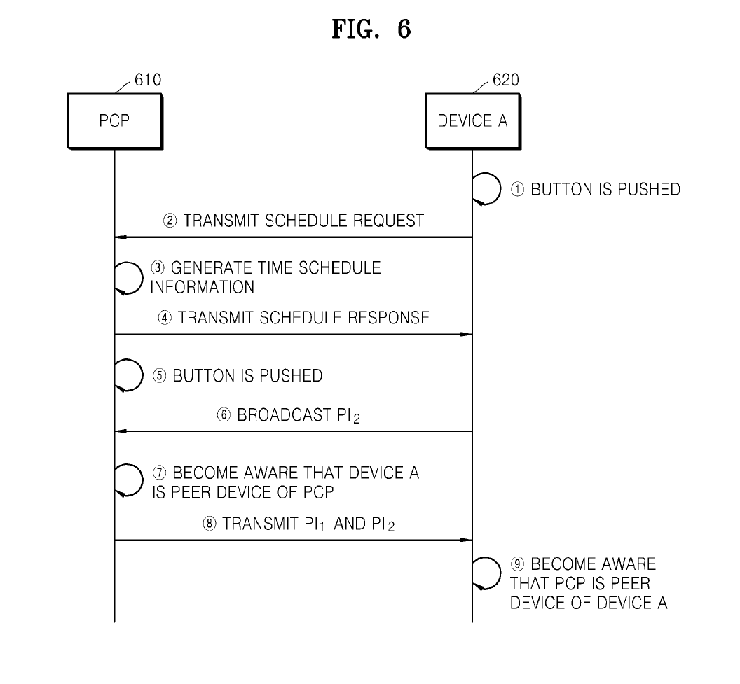

FIG. 6 is a flowchart illustrating a method of performing pairing between a coordinator and a device in a network, according to another exemplary embodiment.

In a first operation, a button for instructing to perform pairing is pushed by a user of a device A 620.

In a second operation, the device A 620 transmits, to a PCP 610, a schedule request to allocate a time period for broadcasting the second pairing information PI₂ indicating that the device A 620 is a device to perform pairing.

In a third operation, the PCP 610 generates time schedule information including the time period for broadcasting the second pairing information PI₂.

In a fourth operation, the PCP 610 transmits to the device A 620 a schedule response including information about the time period for broadcasting the second pairing information PI₂.

In a fifth operation, a button for instructing to perform pairing is pushed by a user of the PCP 610.

In a sixth operation, the device A 620 broadcasts the second pairing information PI₂ based on the schedule response.

In a seventh operation, the PCP 610 becomes aware that the device A 620 is a peer device of the PCP 610.

In an eighth operation, the PCP 610 transmits to the device A 620 the second pairing information PI₂ and first pairing information PI₁ indicating that the device A 620 is a peer device to perform pairing.

In a ninth operation, the device A 620 becomes aware that the PCP 610 is a peer device of the device A 620.

In the above-described exemplary embodiments, methods of performing pairing between a PCP and a device have been described. Specifically, FIGS. 1 and 2 illustrate exemplary embodiments in which a method of performing pairing between the PCP and the device when a button installed at the PCP has been first pushed, and FIGS. 4 and 6 illustrate exemplary embodiments in which a method of performing pairing between the PCP and the device when a button installed at the device has been first pushed. In this way, in the above-described exemplary embodiments, even when a button installed at any one of the PCP and the device has been first pushed, paring between the PCP and the device can be performed. Thus, since pairing is automatically performed by sequentially selecting two devices to be paired, without differentiating whether devices are PCPs or general devices, pairing between devices can be easily performed.

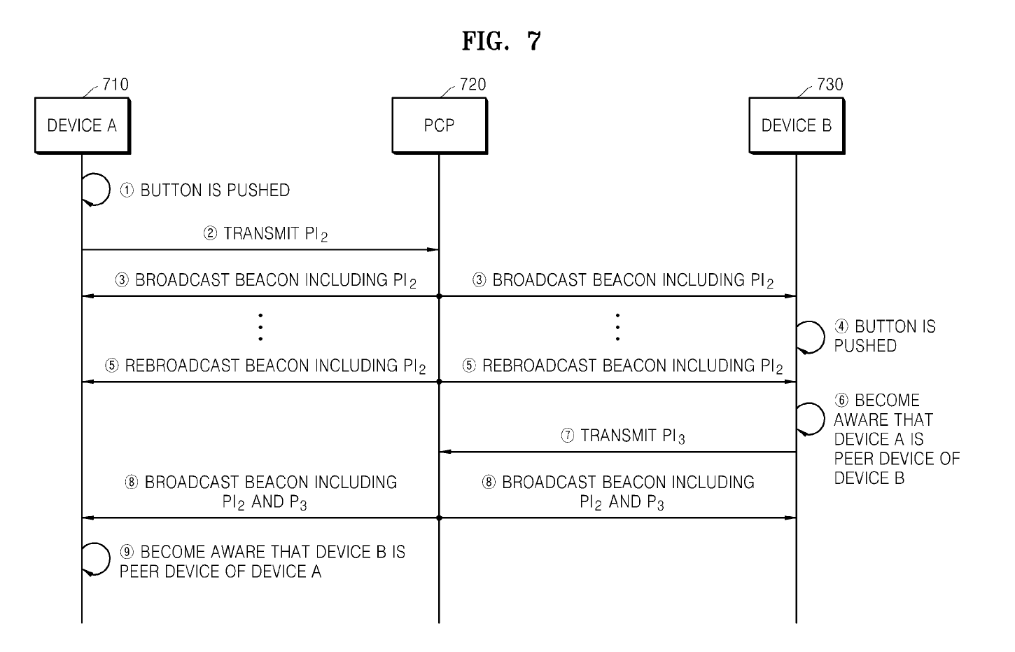

FIG. 7 is a flowchart illustrating a method of performing pairing between devices through a coordinator in a network, according to an exemplary embodiment.

In a first operation, a button for instructing to perform pairing is pushed by a user of a device A 710.

In a second operation, the device A 710 transmits to a PCP 720 second pairing information PI₂ indicating that the device A 710 is a device to perform pairing.

In a third operation, the PCP 720 broadcasts a beacon including the second pairing information PI₂.

As described above, the PCP 720 may broadcast the second pairing information PI₂ in a different time period, instead of broadcasting the beacon including the second pairing information PI₂ in a beacon period.

In this regard, a device B 730 receives the beacon from the PCP 720 but ignores the received beacon because a button for instructing to perform pairing is not pushed by a user of the device B 730. Thus, the device B 730 does not respond to the beacon received from the PCP 720.

In a fourth operation, the button for instructing to perform pairing is pushed by the user of the device B 730.

In a fifth operation, the PCP 720 rebroadcasts the beacon including the second pairing information PI₂.

In this regard, since the button for instructing to perform pairing has been pushed by the user of the device B 730 in the fourth operation, the device B 730 can respond to the beacon received from the PCP 710.

In a sixth operation, the device B 730 becomes aware that the device A 710 is a peer device of the device B 730.

In a seventh operation, the device B 730 transmits to the PCP 720 third pairing information PI₃ indicating that the device B 730 is a peer device to perform pairing.

In this regard, the third pairing information PI₃ may include third PBC information indicating that the button for instructing to perform has been pushed by the user of the device B 730, and an MAC address of the device B 730.

In an eighth operation, the PCP 720 broadcasts a beacon including the second pairing information PI₂ and the third pairing information PI₃.

In a ninth operation, the device A 710 becomes aware that the device B 730 is a peer device of the device A 710.

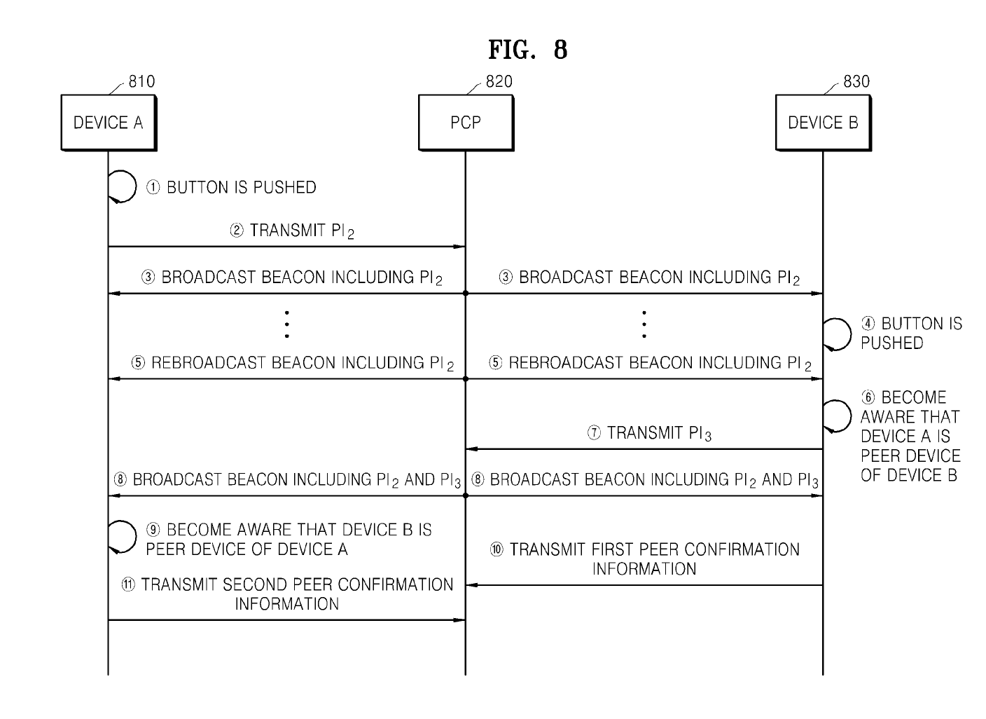

FIG. 8 is a flowchart illustrating a method of performing pairing between devices through a coordinator in a network, according to another exemplary embodiment.

First through ninth operations illustrated in FIG. 8 are the same as those of FIG. 7, and thus, a description thereof is not provided here.

In a tenth operation, a device B 830 transmits to a coordinator 820 first peer confirmation information indicating that the device B 830 becomes aware that a device A 810 is a peer device to be paired with device B 830.

In an eleventh operation, the device A 810 transmits to the coordinator 820 second peer confirmation information indicating that the device A 810 becomes aware that the device B 830 is a peer device to be paired with device A 810.

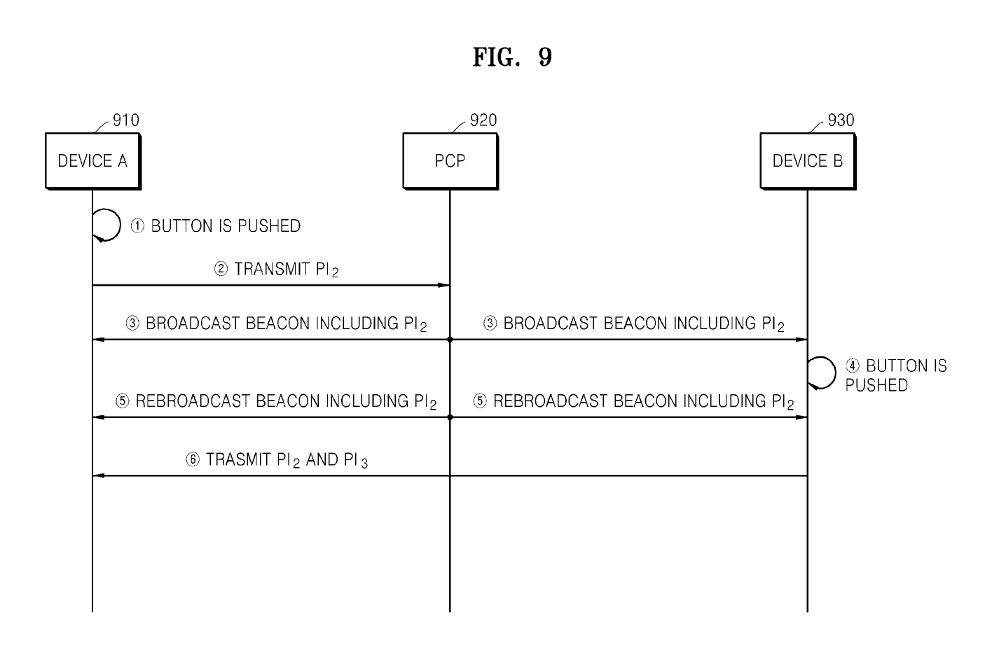

FIG. 9 is a flowchart illustrating a method of performing pairing between devices through a coordinator in a network, according to another exemplary embodiment.

First through fifth operations illustrated in FIG. 9 are the same as those of FIG. 7, and thus, a description thereof is not provided here.

In a sixth operation, a device B 930 transmits to a device A 910 second pairing information PI₂ and third pairing information PI₃ indicating that the device B 930 is a peer device to perform pairing.

In detail, in FIG. 7, the device B 730 transmits the third pairing information PI₃ to the PCP 720, and the PCP 720 broadcasts the beacon including the second pairing information PI₂ and the third pairing information PI₃ so that the device A 710 may obtain the third pairing information PI₃, whereas, in FIG. 9, the device B 930 transmits the third pairing information PI₃ directly to the device A 910 so that the device A 910 may obtain the third pairing information PI₃.

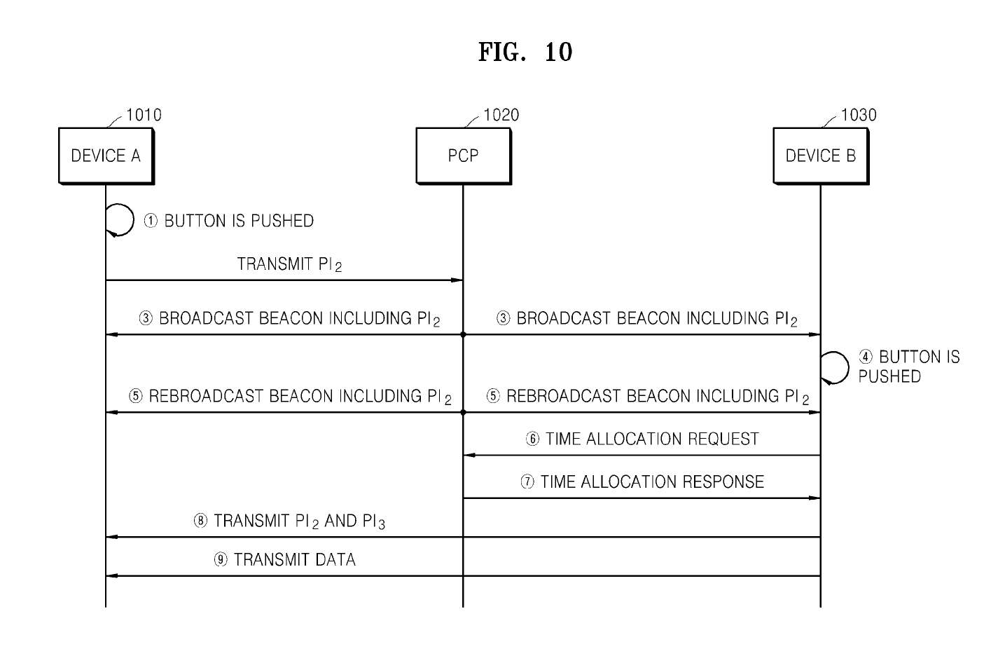

FIG. 10 is a flowchart illustrating a method of performing pairing between devices through a coordinator in a network, according to another exemplary embodiment.

First through fifth operations illustrated in FIG. 10 are the same as those of FIG. 7, and thus, a description thereof is not provided here.

In a sixth operation, a device B 1030 transmits to a PCP 1020 a time allocation request to allocate a time period for transmitting data.

In a seventh operation, the PCP 1020 transmits to the device B 1030 a time allocation response including information about the time period allocated to the device B 1030 for data transmission.

In an eighth operation, the device B 1030 transmits to a device A 1010 second pairing information PI₂ and third pairing information PI₃ indicating that the device B 1030 is a peer device to perform pairing.

In a ninth operation, the device B 1030 transmits data to the device A 1010 based on the time allocation response.

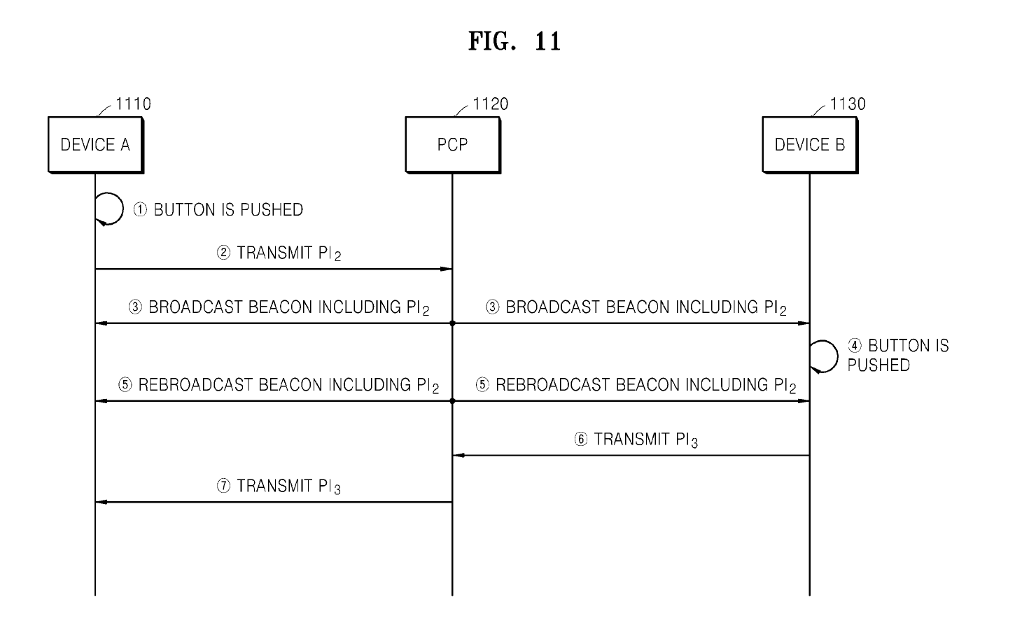

FIG. 11 is a flowchart illustrating a method of performing pairing between devices through a coordinator in a network, according to another exemplary embodiment.

First through fifth operations illustrated in FIG. 11 are the same as those of FIG. 7, and thus, a description thereof is not provided here.

In a sixth operation, a device B 1130 transmits to a PCP 1120 third pairing information PI₃ indicating that the device B 1130 is a peer device to perform pairing.

In a seventh operation, the PCP 1120 transmits the third pairing information PI₃ to a device A 1110.

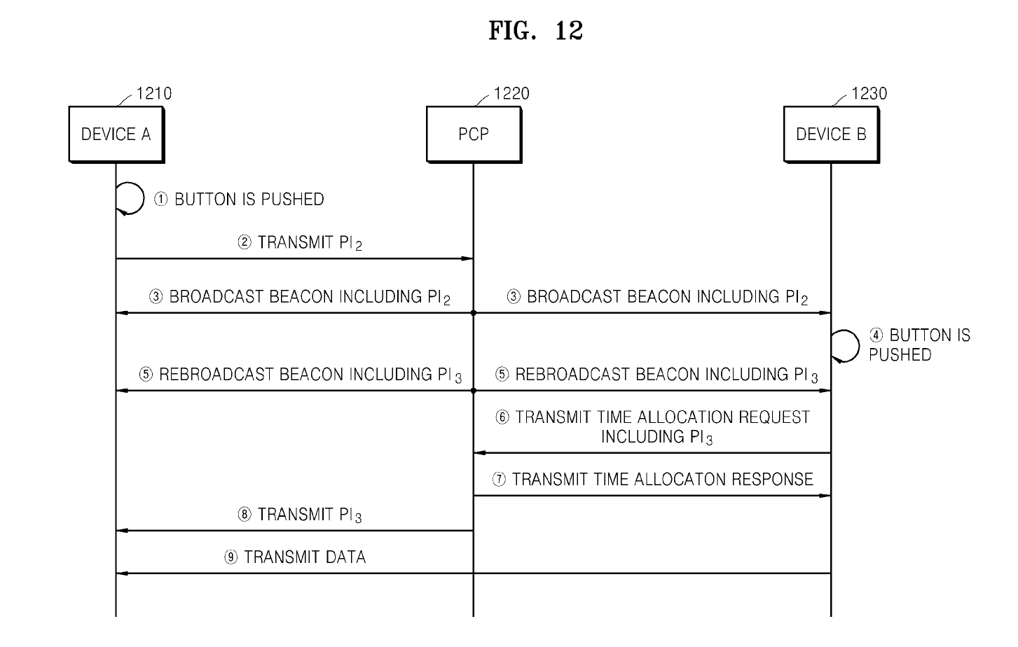

FIG. 12 is a flowchart illustrating a method of performing pairing between devices through a coordinator in a network, according to another exemplary embodiment.

First through fifth operations illustrated in FIG. 12 are the same as those of FIG. 7, and thus, a description thereof is not provided here.

In a sixth operation, a device B 1230 includes third pairing information PI₃ indicating that the device B 1230 is a peer device to perform pairing and transmits to a PCP 1220 a time allocation request to allocate a time period for transmitting data.

In a seventh operation, the PCP 1220 transmits to the device B 1230 a time allocation response including information about the time period allocated to the device B 1230 for data transmission.

In an eighth operation, the PCP 1220 transmits the third pairing information PI₃ to a device A 1210.

In a ninth operation, the device B 1230 transmits data to the device A 1210 based on the time allocation response.

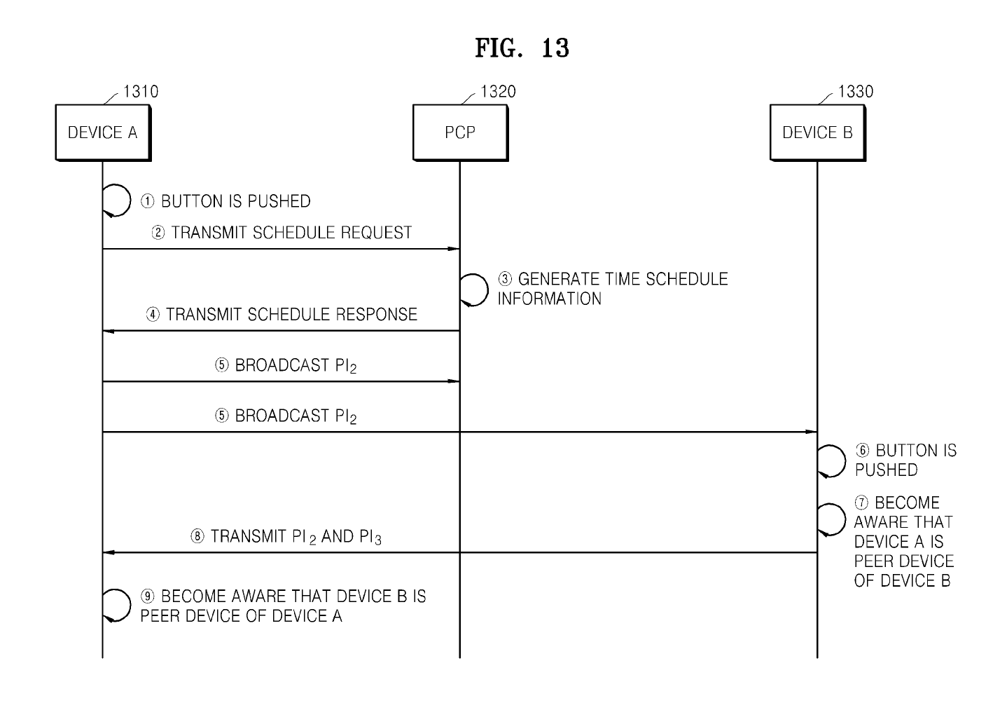

FIG. 13 is a flowchart illustrating a method of performing pairing between devices through a coordinator in a network, according to another exemplary embodiment.

In a first operation, a button for instructing to perform pairing is pushed by a user of a device A 1310.

In a second operation, the device A 1310 transmits to a PCP 1320 a schedule request to allocate a time period for broadcasting second pairing information PI₂ indicating that the device A 1310 is a device to perform pairing.

In a third operation, the PCP 1320 generates time schedule information including the time period for broadcasting the second pairing information PI₂.

In a fourth operation, the PCP 1320 transmits to the device A 1310 a schedule response including information about the time period for broadcasting the second pairing information PI₂.

In a fifth operation, the device A 1310 broadcasts the second pairing information

PI₂ based on the schedule response.

In a sixth operation, a button for instructing to perform pairing is pushed by a user of a device B 1330.

In a seventh operation, the device B 1330 becomes aware that the device A 1310 is a peer device of the device B 1330.

In an eighth operation, the device B 1330 transmits to the device A 1310 the second pairing information PI₂ and third pairing information PI₃ indicating that the device B 1330 is a peer device to perform pairing.

In a ninth operation, the device A 1310 becomes aware that the device B 1330 is a peer device of the device A 1310.

In the exemplary embodiments described above with reference to FIGS. 7 through 13, even when a button is not installed at a PCP or is not pushed, but each of buttons installed at two devices is pushed, pairing between the two devices can be performed through the PCP. Thus, since pairing is automatically performed by sequentially selecting two devices to be paired, without differentiating whether devices are PCPs or general devices or without the need of being aware that the PCP or device belongs to a predetermined network, pairing between devices can be easily performed.

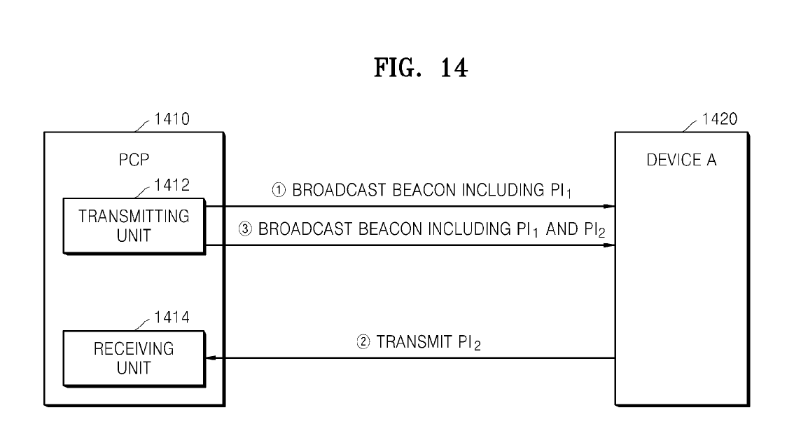

FIG. 14 is a flowchart for explaining a coordinator that performs pairing between the coordinator and a device in a network, according to an exemplary embodiment. FIG. 14 further illustrates a device A 1420 to perform paring with a PCP 1410 for convenience of explanation.

Referring to FIG. 14, the PCP 1410 according to the current exemplary embodiment includes a transmitting unit 1412 and a receiving unit 1414.

The transmitting unit 1412 broadcasts a beacon including first pairing information PI₁ indicating that the PCP 1410 is a device to perform pairing.

The receiving unit 1414 receives from the device A 1420 second pairing information PI₂ indicating that the device A 1420 is a device to perform pairing.

Next, the transmitting unit 1412 broadcasts a beacon including the first pairing information PI₁ and the second pairing information PI₂.

Although not shown, the transmitting unit 1412 may further transmit the first pairing information PI₁ and the second pairing information PI₂ to the device A 1420 in a predetermined time period, instead of the beacon. Also, the receiving unit 1414 may further receive the first pairing information PI₁ from the device A 1420.

Also, the PCP 1410 according to the current exemplary embodiment may further include a schedule information generating unit (not shown) for generating time schedule information including a time period for broadcasting the first pairing information PI₁.

The transmitting unit 1412 may transmit the first pairing information PI₁ and the second pairing information PI₂ to the device A 1420 in the predetermined time period based on the time schedule information generated by the schedule information generating unit.

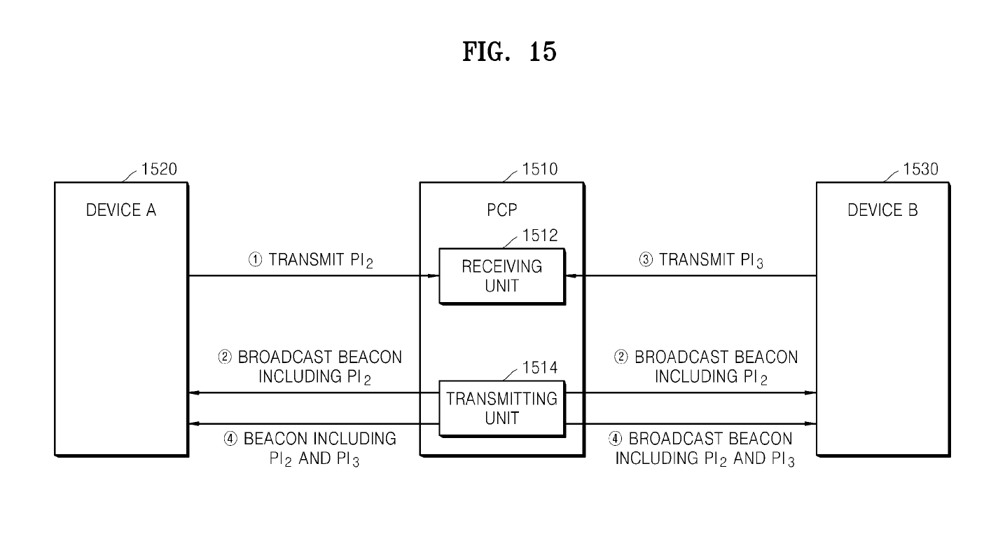

FIG. 15 is a flowchart for explaining a coordinator that performs pairing between devices in a network, according to an exemplary embodiment. FIG. 15 further illustrates a device A 1520 and a device B 1530 to perform paring therebetween through a PCP 1510 for convenience of explanation.

Referring to FIG. 15, the PCP 1510 according to the current exemplary embodiment includes a receiving unit 1512 and a transmitting unit 1514.

The receiving unit 1512 receives from the device A 1520 second pairing information PI₂ indicating that the device A 1520 is a device to perform pairing.

The transmitting unit 1514 broadcasts a beacon including the second pairing information PI₂.

Next, the receiving unit 1512 receives third pairing information PI₃ indicating that the device B 1530 is a peer device to perform pairing, from the device B 1530.

Next, the transmitting unit 1514 broadcasts a beacon including the second pairing information PI₂ and the third pairing information PI₃.

According to one or more other exemplary embodiments, the receiving unit 1512 may receive further the second pairing information PI₂ from the device B 1530. Also, the transmitting unit 1514 may further broadcast the second pairing information PI₂ and the third pairing information PI₃ to the device A 1520 and the device B 1530 in a predetermined time period, instead of the beacon.

Also, the device B 1530 may further transmit the second pairing information PI₂ and the third pairing information PI₃ directly to the device A 1520.

Each of the PCP 1510, the device A 1520, and the device B 1530 may further include a button (not shown) for instructing to perform pairing.

An exemplary embodiment can also be embodied as computer readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, etc. Moreover, one or more units of any of the above-described devices can include a processor or microprocessor executing a computer program stored in a computer-readable medium.

While exemplary embodiments have been particularly shown and described above, it will be understood by those skilled in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the detailed description of exemplary embodiments, but by the appended claims, and all differences within the scope will be construed as being included in the present invention.

What is claimed is:

1. A method of performing pairing between a coordinator and a peer device that is one from among a plurality of devices in a network comprising the plurality of devices and the coordinator, the method comprising:
broadcasting first pairing information indicating that the coordinator is a device to perform pairing;
receiving, from the peer device, second pairing information indicating that the peer device is a peer device to perform pairing; and
broadcasting the first pairing information and the second pairing information.

2. The method of claim 1, wherein:
the first pairing information comprises at least one of first Push Button Configuration (PBC) information indicating that a button for instructing to perform pairing has been pushed in the coordinator, and a media access control (MAC) address of the coordinator; and
the second pairing information comprises at least one of second PBC information indicating that a button for instructing to perform pairing has been pushed in the peer device, and an MAC address of the peer device.

3. The method of claim 1, wherein the broadcasting the first pairing information and the second pairing information comprises broadcasting the first pairing information and the second pairing information in one time period from among time periods in which data transmission between the peer device and the coordinator is performed, or broadcasting the first pairing information and the second pairing information in an announcement time period for notifying information in the network.

4. A method of performing pairing between a coordinator and a peer device that is one from among a plurality of devices in a network comprising the plurality of devices and the coordinator, the method comprising:
broadcasting first pairing information indicating that the coordinator is a device to perform pairing; and
receiving, from the peer device, the first pairing information and second pairing information indicating that the peer device is a peer device to perform pairing.

5. The method of claim 4, further comprising:
if a button for instructing to perform pairing is pushed in the coordinator, generating time schedule information comprising a time period for broadcasting the first pairing information,
wherein the broadcasting of the first pairing information is performed based on the generated time schedule information.

6. A method of performing pairing between a coordinator and a peer device that is one from among a plurality of devices in a network comprising the plurality of devices and the coordinator, the method comprising:
receiving, from the peer device, second pairing information indicating that the peer device is a peer device to perform pairing; and
broadcasting the second pairing information and first pairing information indicating that the coordinator is a device to perform pairing.

7. The method of claim 6, further comprising:
if the second pairing information is received from the peer device, broadcasting a beacon comprising the second pairing information,
wherein the broadcasting the second pairing information and the first pairing information is performed when a button for instructing to perform pairing is pushed in the coordinator after the second pairing information is broadcasted.

8. A method of performing pairing between a coordinator and a peer device that is one from among a plurality of devices in a network comprising the plurality of devices and the coordinator, the method comprising:
receiving, from the peer device, a schedule request to allocate a time period for broadcasting second pairing information indicating that the peer device is a device to perform pairing;
transmitting a schedule response comprising information about the time period for broadcasting the second pairing information to the peer device;
receiving, from the peer device, the broadcasted second pairing information based on the schedule response; and
transmitting, to the peer device, the second pairing information and first pairing information indicating that the coordinator is a peer device to perform pairing.

9. A method of performing pairing between a plurality of devices through a coordinator in a network comprising the plurality of devices and the coordinator, the method comprising:
receiving, by the coordinator and from a first device, second pairing information indicating that the first device is a device to perform pairing;
broadcasting, by the coordinator, the second pairing information;
receiving, by the coordinator and from a second device, third pairing information indicating that the second device is a peer device to perform pairing; and
broadcasting, by the coordinator, the second pairing information and the third pairing information.

10. The method of claim 9, wherein the broadcasting the second pairing information and the third pairing information comprises broadcasting the second pairing information and the third pairing information in one time period from among time periods in which data transmission between the peer device and the coordinator is performed, or broadcasting the second pairing information and the third pairing information in an announcement time period for notifying information in the network.

11. The method of claim 9, further comprising:
receiving, from the second device, first peer confirmation information indicating that the second device becomes aware that the first device is a peer device to be paired with the second device; and
receiving, from the first device, second peer confirmation information indicating that the first device becomes aware that the second device is a peer device to be paired with the first device.

12. The method of claim 9, wherein:
the second pairing information comprises at least one of second Push Button Configuration (PBC) information indicating that a button for instructing to perform pairing has been pushed in the first device, and a media access control (MAC) address of the first device; and
the third pairing information comprises at least one of third PBC information indicating that a button for instructing to perform pairing has been pushed in the second device, and an MAC address of the second device.

13. The method of claim 12, further comprising:
if the second pairing information is received by the second device, buffering, by the second device, the received second pairing information; and
if a button for instructing to perform pairing is pushed in the second device, becoming aware that the first device is a peer device of the second device based on the buffered second pairing information,
wherein the third pairing information is transmitted from the second device to the coordinator when the second device becomes aware that the first device is the peer device of the second device.

14. The method of claim 12, wherein:
if the second pairing information is received by the second device before the button for instructing to perform pairing is pushed in the second device, the second device ignores the received second pairing information; and
if the second pairing information is received by the second device after the button for instructing to perform pairing is pushed in the second device, the second device becomes aware that the first device is a peer device of the second device, and the third pairing information is transmitted from the second device to the coordinator when the second device becomes aware that the first device is the peer device of the second device.

15. A method of performing pairing between a plurality of devices through a coordinator in a network comprising the plurality of devices and the coordinator, the method comprising:
transmitting, by a first device and to the coordinator, second pairing information indicating that the first device is a device to perform pairing;
broadcasting, by the coordinator, the second pairing information; and
transmitting, by a second device and to the first device, the second pairing information and third pairing information indicating that the second device is a peer device to perform pairing.

16. The method of claim 15, further comprising:
transmitting, by the second device and to the coordinator, a time allocation request to allocate a time period for transmitting data; and
transmitting, by the coordinator, a time allocation response comprising information about the time period allocated to the second device for transmission of the data,
wherein the first device and the second device mutually transmit data based on the time allocation response.

17. A method of performing pairing between a plurality of devices through a coordinator in a network comprising the plurality of devices and the coordinator, the method comprising:
transmitting, by a first device and to the coordinator, second pairing information indicating that the first device is a device to perform pairing;
broadcasting, by the coordinator, the second pairing information;
transmitting, by the second device and to the coordinator, third pairing information indicating that the second device is a peer device to perform pairing; and
transmitting, by the coordinator and to the first device, the third pairing information.

18. The method of claim 17, further comprising, when the transmitting the third pairing information to the coordinator is performed by transmitting, by the second device, a time allocation request that comprises the third pairing information to allocate a time period for transmitting data to the coordinator, transmitting, by the coordinator and to the second device, a time allocation response comprising information about the time period allocated to the second device for transmission of the data.

19. A method of performing pairing between a plurality of devices through a coordinator in a network comprising the plurality of devices and the coordinator, the method comprising:
transmitting, by a first device and to the coordinator, a schedule request to allocate a time period for broadcasting second pairing information indicating that the first device is a device to perform pairing;
transmitting, by the coordinator and to the first device, a schedule response comprising information about the time period allocated to the first device for broadcasting of the second pairing information;
broadcasting, by the first device, the second pairing information based on the schedule response; and
transmitting, by the second device and to the first device, the second pairing information and third pairing information indicating that the second device is a peer device to perform pairing.

20. A coordinator for performing pairing between a coordinator and a peer device that is one from among a plurality of devices in a network comprising the plurality of devices and the coordinator, the coordinator comprising:
a transmitting unit which broadcasts first pairing information indicating that the coordinator is a device to perform pairing; and
a receiving unit which receives, from the peer device, second pairing information indicating that the peer device is a peer device to perform pairing,
wherein the transmitting unit broadcasts the first pairing information and the second pairing information.

21. The coordinator of claim 20, wherein:
the first pairing information comprises at least one of first Push Button Configuration (PBC) information indicating that a button for instructing to perform pairing has been pushed in the coordinator, and a media access control (MAC) address of the coordinator; and
the second pairing information comprises at least one of second PBC information indicating that a button for instructing to perform pairing has been pushed in the peer device, and an MAC address of the peer device.

22. The coordinator of claim 20, wherein the transmitting unit broadcasts the first pairing information and the second pairing information in one time period from among time periods in which data transmission between the peer device and the coordinator is performed, or broadcasts the first pairing information and the second pairing information in an announcement time period for notifying information in the network.

23. A coordinator for performing pairing between a coordinator and a peer device that is one from among a plurality of devices in a network comprising the plurality of devices and the coordinator, the coordinator comprising:
a transmitting unit which broadcasts first pairing information indicating that the coordinator is a device to perform pairing; and
a receiving unit which receives, from the peer device, the first pairing information and second pairing information indicating that the peer device is a peer device to perform pairing.

24. The coordinator of claim 23, further comprising:
a schedule information generating unit which generates, if a button for instructing to perform pairing is pushed in the coordinator, time schedule information comprising a time period for broadcasting the first pairing information,
wherein the transmitting unit broadcasts the first pairing information based on the generated time schedule information.

25. A coordinator for performing pairing between a coordinator and a peer device that is one from among a plurality of devices in a network comprising the plurality of devices and the coordinator, the coordinator comprising:
a receiving unit which receives, from the peer device, second pairing information indicating that the peer device is a device to perform pairing; and
a transmitting unit which broadcasts the second pairing information and first pairing information indicating that the coordinator is a device to perform pairing.

26. The coordinator of claim 25, wherein, if the second pairing information is received from the peer device, the transmitting unit further broadcasts the second pairing information, and the transmitting unit broadcasts the first pairing information and the second pairing information when a button for instructing to perform pairing is pushed in the coordinator after the second pairing information is broadcasted.

27. A coordinator for performing pairing between a coordinator and a peer device that is one from among a plurality of devices in a network comprising the plurality of devices and the coordinator, the coordinator comprising:
a receiving unit which receives, from the peer device, a schedule request to allocate a time period for broadcasting second pairing information indicating that the peer device is a device to perform pairing; and
a transmitting unit which transmits a schedule response comprising information about the time period for broadcasting the second pairing information to the peer device,
wherein the receiving unit further receives, from the peer device the broadcasted second pairing information based on the schedule response, and the transmitting unit further transmits, to the peer device, the second pairing information and first pairing information indicating that the coordinator is a peer device to perform pairing.

28. A coordinator for performing pairing between a plurality of devices in a network comprising the plurality of devices and the coordinator, the coordinator comprising:
a receiving unit which receives, from a first device, second pairing information indicating that the first device is a device to perform pairing; and
a transmitting unit which broadcasts the second pairing information,
wherein the receiving unit further receives, from a second device, third pairing information indicating that the second device is a peer device to perform pairing, and the transmitting unit broadcasts the second pairing information and the third pairing information.

29. The coordinator of claim 28, wherein the transmitting unit broadcasts the second pairing information and the third pairing information in one time period from among time periods in which data transmission between the peer device and the coordinator is performed, or broadcasts the second pairing information and the third pairing information in an announcement time period for notifying information in the network.

30. The coordinator of claim 28, wherein the receiving unit further receives, from the second device, first peer confirmation information, indicating that the second device becomes aware that the first device is a peer device to be paired with the second device, and second peer confirmation information indicating that the first device becomes aware that the second device is a peer device to be paired with the first device.

31. The coordinator of claim 28, wherein:
the second pairing information comprises at least one of second Push Button Configuration (PBC) information indicating that a button for instructing to perform pairing has been pushed in the first device, and a media access control (MAC) address of the first device; and
the third pairing information comprises at least one of third PBC information indicating that a button for instructing to perform pairing has been pushed in the second device, and an MAC address of the second device.

32. The coordinator of claim 31, wherein:
if the second pairing information is received by the second device, the second device buffers the received second pairing information;
if a button for instructing to perform pairing is pushed in the second device, the second device becomes aware that the first device is a peer device of the second device based on the buffered second pairing information; and
the third pairing information is transmitted from the second device to the coordinator when the second device becomes aware that the first device is the peer device of the second device.

33. The coordinator of claim 31, wherein:
if the second pairing information is received by the second device before the button for instructing to perform pairing is pushed in the second device, the second device ignores the received second pairing information; and
if the second pairing information is received by the second device after the button for instructing to perform pairing is pushed in the second device, the second device becomes aware that the first device is a peer device of the second device, and the third pairing information is transmitted from the second device to the coordinator when the second device becomes aware that the first device is the peer device of the second device.

34. A network system comprising a coordinator and a plurality of devices to perform pairing through the coordinator, the network system comprising:
a first device which transmits, to the coordinator, second pairing information indicating that the first device is a device to perform pairing;
a coordinator which broadcasts the second pairing information; and
a second device which transmits, to the first device, the second pairing information and third pairing information indicating that the second device is a peer device to perform pairing.

35. The network system of claim 34, wherein:
the second device further transmits, to the coordinator, a time allocation request to allocate a time period for transmitting data;
the coordinator further transmits, to the second device, a time allocation response comprising information about the time period allocated to the second device for transmission of the data; and
the first device and the second device mutually transmit data based on the time allocation response.

36. A network system comprising a coordinator and a plurality of devices to perform pairing through the coordinator, the network system comprising:
a first device which transmits, to the coordinator, second pairing information indicating that the first device is a device to perform pairing;
a coordinator which broadcasts the second pairing information; and
a second device which transmits, to the coordinator, third pairing information indicating that the second device is a peer device to perform pairing, and
wherein the coordinator further transmits, to the first device, the third pairing information.

37. The network system of claim 36, wherein, if the second device transmits, to the coordinator, the third pairing information by transmitting a time allocation request that comprises the third pairing information to allocate a time period for transmitting data to the coordinator by the second device, the coordinator transmits, to the second device, a time allocation response comprising information about the time period allocated to the second device for transmission of the data.

38. A network system comprising a coordinator and a plurality of devices to perform pairing through the coordinator, the network system comprising:
a first device which transmits, to the coordinator, a schedule request to allocate a time period for broadcasting second pairing information indicating that a first device is a device to perform pairing;
a coordinator which transmits, to the first device, a schedule response comprising information about the time period allocated to the first device for broadcasting of the second pairing information; and
a second device which, if the first device broadcasts the second pairing information based on the schedule response, transmits, to the first device, the second pairing information and third pairing information indicating that the second device is a peer device to perform pairing.

39. A computer-readable recording medium having recorded thereon a computer program for executing the method of claim 1.
